(19) United States
(12) Patent Application Publication
(10) Pub. No.: US 2009/0039665 A1
(43) Pub. Date: Feb. 12, 2009

(54) GRIPPER

(75) Inventors: Craig Norman BRYANT, Vermont (AU); William John SCHOLTES, Pascoe Vale South (AU); Jacobus Albertus BERGER, Upwey (AU); Peter James SOMOGYI, Sunday Creek (AU)

Correspondence Address: ROTHWELL, FIGG, ERNST & MANBECK, P.C., 1425 K STREET, N.W., SUITE 800, WASHINGTON, DC, 20005, US

(73) Assignee: VISY R & D PTY LTD, Melbourne (AU)

(21) Appl. No.: 12/185,235

(22) Filed: Aug. 4, 2008

(30) Foreign Application Priority Data
Aug. 10, 2007 (AU) 2007205734

(51) Int. Cl. B66C 1/42; B25J 15/00

(52) U.S. Cl. 294/104; 294/103.1; 901/30

(57) ABSTRACT

A gripper 1 comprising a support 5, 6 for attachment to a robotic arm, outer gripping plates 2, 3 mounted for movement on the support, drive means 13, 14, 15 for independently moving the outer plates 2 and 3 with respect to an intermediate gripping plate 4 mounted for pivotal movement towards and away from the outer plates 2, 3, the arrangement allowing for separate articles or groups of articles to be gripped between each of the outer plates 2, 3 and the intermediate plate 4 to increase the capacity of the gripper 1.

### FIELD

This invention relates to improvements in grippers for gripping and transporting articles, such as boxes during palletising of the articles using a robotic arm.

### BACKGROUND

Known grippers usually include two opposed gripping plates which are moved towards and away from each other by a suitable driving mechanism to grip and release articles or groups of articles during palletising of the articles for subsequent transport. While such grippers have met with great success, they are limited by the ability to grip only one article, or a suitably assembled group of articles, for positioning and release. The present inventors have recognised that it would be an advantage to allow the gripping of multiple articles or assembled groups of articles for subsequent release at different positions, to thereby reduce the number of gripping operations necessary to transfer a predetermined number of articles.

### SUMMARY

With the above in mind, the invention provides a gripper for positioning articles on a conveyor or pallet, comprising a support for attachment to a robotic arm, gripper plates mounted for movement on the support to grip and release the articles, drive means for moving the gripper plates with respect to each other to grip and release articles, said gripper plates including outer gripping plates and an intermediate gripping plate between the outer plates, the outer plates being independently moveable to grip articles between each of the outer plates and the intermediate plate to thereby increase the capacity of the gripper.

In one form, the intermediate plate is mounted along a fixed axis against transverse movement with respect to the outer plates.

The intermediate plate may be mounted to allow pivotal movement towards and away from each of the outer plates to assist in the gripping and release of articles from between each of the outer plates and the intermediate plate. The pivotal movement may be limited to about 2° to 10°.

The plates are suitably mounted to depend from cross members, and the cross members supporting the intermediate plate may be pivotally mounted. to allow for the tilting or pivotal movement referred to above.

The tilting or pivotal movement of the intermediate plate may be achieved by toggle members mounted on the cross member supporting the intermediate plate, and actuator means for moving push rods operably connected to the toggle members to cause the required pivotal movement.

Other features of the improved gripper will be described in further detail in the following description of an embodiment of the improved gripper.

### BRIEF DESCRIPTIONS OF THE DRAWINGS

In the accompanying drawings:

FIG. 1 is a perspective view of a gripper embodying the invention;

FIG. 2 is a perspective view from one side of the gripper with the housing illustrated in FIG. 1 and other parts of the structure removed for clarity, and

FIG. 3 is a perspective view from one end of the gripper illustrated in FIG. 2 which shows the pivoting or tilting mechanism for the intermediate plate.

### DESCRIPTION OF EMBODIMENT

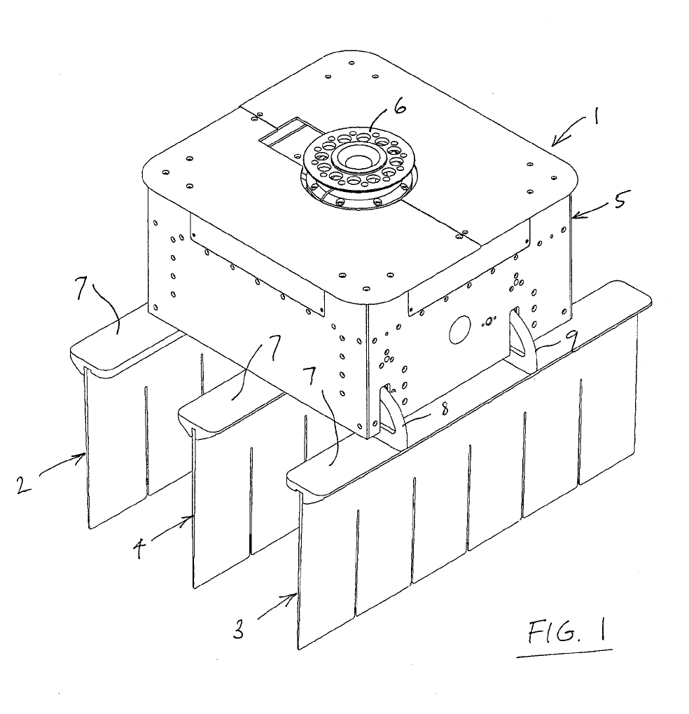

Referring to FIG. 1 of the drawings, the gripper 1 comprises outer gripping plates 2, 3 and a fixed position intermediate gripping plate 4, the outer gripping plates 2, 3 being mounted for movement towards and away from the intermediate plate 4 on a supporting structure 5 having an attachment and impact sensing collar 6 by means of which the gripper 1 may be mounted on a robotic arm (not shown).

Referring to FIGS. 1 to 3, each outer plate 2, 3 is mounted on a cross member 7 carried by separate pairs of arms 8, 9 having linear bearings 10 which engage tracks 11 on cross members 12 forming part of the support structure 5. Each arm 8, 9 carries a ball nut 14 which is engaged by a ball screw 13, the ball screws 13 associated with the respective arms 8 and 9 being separately driven by servo motor drive mechanisms 15 arranged at opposite sides of the support structure 5. Each drive mechanism 15 is independently operable so that gripping plates 2 and 3 are independently moveable with respect to the intermediate gripping plate 4 to allow gripping of separate articles or groups of articles (not shown) between each of the outer plates 2 and 3 and the intermediate plate 4.

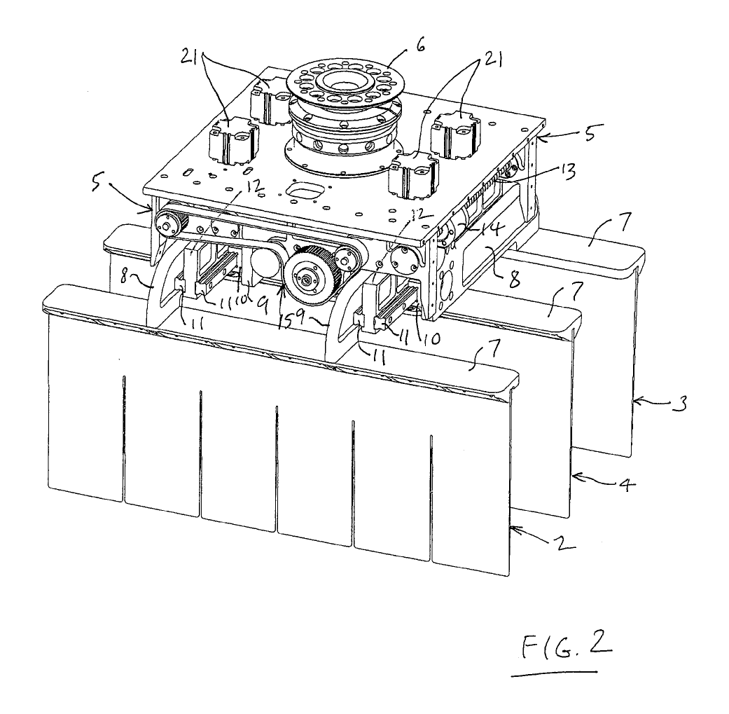

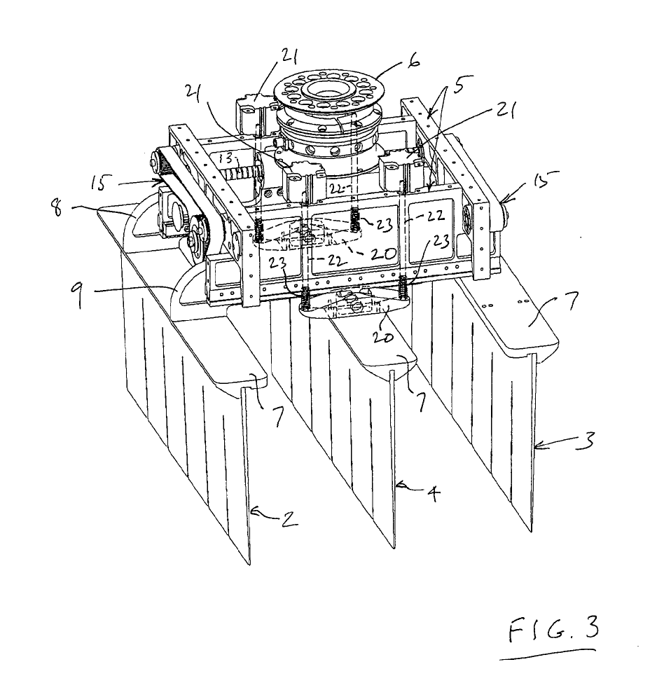

The intermediate plate 4 is also supported by a cross bar 7, but this cross bar 7 has a pair of toggle members 20 (FIGS. 2 and 3) mounted at spaced positions on its upper surface. The cross bar 7 for the intermediate plate 4 is pivotally mounted on the support structure 5 so that the intermediate plate can be pivoted towards and away from the respective outer gripping plates 2 and 3 to a limited extent of about 2° to 10°. Pivotal movement is achieved by pneumatic actuators 21 which operate push rods 22 engaging springs 13 mounted in seats 14 at either end of each toggle member 20.

Since the outer gripping plates 2 and 3 are independently moveable towards and away from the intermediate gripping plate 4, the gripper 1 can pick up two or more articles or groups of articles and place them in either one or two positions. In this way, the number of picks per operation is one or two and the number of drops is one or two. The intermediate blade 4 is in a fixed central position, but can be tilted by operation of the actuators 21 to allow one pick and then another pick, and then either one or two drops. If only one pick is made, the intermediate blade may be tilted towards one of the outer blades to ensure that the article is securely gripped.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A gripper for positioning articles on a conveyor or pallet, comprising a support for attachment to a robotic arm, gripper plates mounted for movement on the support to grip and release the articles, drive means for moving the gripper plates with respect to each other to grip and release articles, said gripper plates including outer gripping plates and an intermediate gripping plate between the outer plates, the outer plates being independently moveable to grip articles between each of the outer plates and the intermediate plate to thereby increase the capacity of the gripper.

2. The gripper of claim 1, wherein the intermediate plate is mounted along a fixed axis against transverse movement with respect to the outer plates.

3. The gripper of claim 1, wherein the intermediate plate is mounted to allow pivotal movement towards and away from each of the outer plates.

4. The gripper of claim 3, wherein the pivotal movement is limited to about 2° to 10°.

5. The gripper of claim 1, wherein the plates are mounted in a depending manner from cross members.

6. The gripper of claim 5, wherein the cross member supporting the intermediate plate is pivotally mounted.

7. The gripper of claim 6, wherein pivotal movement of the cross member supporting the intermediate plate is achieved by actuators moving push rods operably connected to toggle members mounted on the cross member.

8. The gripper of claim 1, wherein the cross member supporting the outer plates are secured to separate pairs of arms carrying linear bearings which engage tracks on cross members forming part of the support.

9. The gripper of claim 1, wherein the drive means includes ball nuts carried by the arms engaged by ball screws, the ball screws associated with the arms carrying the respective outer plates being driven by independent driving mechanisms carried by the support.

10. A gripper substantially as hereinbefore described with reference to the accompanying drawings.
